(19) United States
(12) Patent Application Publication
(10) Pub. No.: US 2010/0296913 A1
(43) Pub. Date: Nov. 25, 2010

(54) WIND POWER GENERATING SYSTEM WITH VERTICAL AXIS JET WHEEL TURBINE

(75) Inventor: Seung-bae Lee, Seoul (KR)

Correspondence Address: LRK Patent Law Firm, 1952 Gallows Rd, Suite 200, Vienna, VA, 22182, US

(73) Assignee: AERONET CO., INC., Incheon (KR)

(21) Appl. No.: 12/445,927

(22) PCT Filed: Jun. 15, 2007
(86) PCT No.: PCT/KR07/02902

§ 371 Date: Apr. 16, 2009

(30) Foreign Application Priority Data
Oct. 18, 2006 (KR) 10-2006-0101180

(51) Int. Cl. F03D 3/02; H02P 9/04; F03D 7/06

(52) U.S. Cl. 415/4.2; 290/44; 415/208.1; 415/148; 416/231 R

(57) ABSTRACT

A wind power generating system that is a technology for converting wind energy to electrical energy is provided. The system blocks flow of air inside the impeller, so that a high speed jet pressure on an I.G.V. (inlet guide vane) is converted to a constant pressure between the blades disposed downstream of the flow which has passed through the inlet guide vane, thus generating a large amount of torque.

### TECHNICAL FIELD

The present invention relates to a cross flow wind turbine with a vertical axis and a power generating system employing the same, and more particularly, to a cross flow wind turbine with a vertical axis and a power generating system employing the same with a higher power coefficient than turbines with horizontal axes, that do not cause noise pollution in the vicinity, that require a minimum of land, and which can be transported over land routes regardless of how large their capacities are.

### BACKGROUND ART

In the face of climate change pacts, the ratification of the Kyoto Protocol, and increasing environmental concerns, there is a growing need to break from our reliance on fossil fuels and nuclear energy and adopt an environmentally friendly, non-depletable source of energy such as wind power. As a naturally occurring phenomenon, wind is a clean energy that does not produce any harmful byproducts, and is thus viewed as a viable alternate energy to fossil fuel-derived energy that is linked to severe environmental concerns including global warming.

Wind generators employ technology to convert movement of wind to electrical energy. In 2004, the generating capacity of the total number of wind generators installed across the globe amounted to 40,300 MW, or the approximate equivalent to the capacity of 40 nuclear reactors, which is electricity that can power 2,300 homes. In the early 1980s during the [symbol] ind Rush? wind generators were of comparatively small scale, with an impeller diameter of 15 m and a capacity of 55 KW; however, wind generators on the market today have increased in scale (with an impeller diameter of 50-1000 and capacity (of 750-2,000 KW).

Wind generators can largely be divided into vertical-axis and horizontal-axis generators. Generators with vertical rotating axes include the widely known Darrieus-type generator, generators with an H-shaped blade, and Savonius impeller-type generators. The advantage of such vertical shaft generators is that they do not require a yawing device required by generators with horizontal axes. However, generators with vertical axes are generally less efficient at energy conversion compared to generators with horizontal axes, and are prone to vibration.

Mid to large-sized wind generators generally use inexpensive and sturdy induction-type generators which are directly connected to electrical power systems, and are designed to rotate at a constant speed according to the fixed frequency of the electrical power systems, regardless of constantly changing wind speeds. Here, because the generator and the impeller can rotate at different speeds, the rotating speed of the impeller may be determined by a gear ratio of intermediate gears for altering speed.

However, in order to overcome the problem of low energy conversion efficiency brought about by a wind speed that falls outside designed wind speed parameters, a tip speed ratio is maintained, and the use of a method that controls the rotating speed of the impeller in a continuously variable manner has recently found favor in the industry.

The aerodynamic power coefficient (Cp) of a wind turbine is a ratio of shaft power generated by the turbine impeller to the wind power exerted on the impeller, and can be calculated using the following equation.

$${C}_{p} = \frac{T \times ω}{\frac{1}{2} p \times {U}^{3} \times A} \qquad [ Equation 1 ]$$

In Equation 1, T is torque (N·m), ω(rad/s) is the angular speed, p(kg/m³) is the air density, U(m/s) is wind speed, and A(m²) is the area that the impeller passes through while rotating or the projected area of the turbine.

Also, the speed coefficient λ (also called the tip speed ratio) is a ratio of the tip speed ratio (Vₜᵢₚ) to the oncoming wind speed, and when the type of turbine is decided on, generally, the maximum power coefficient value can be calculated using Equation 2 below.

$$λ = \frac{{V}_{tip}}{U} = \frac{r \times ω}{U} \qquad [ Equation 2 ]$$

The performance of the wind turbine is determined by the power coefficient Cₚ in Equation 1. Cₚ is the ratio of turbine output to the power of the oncoming air. In other words, it can be seen as the energy conversion efficiency. According to the Betz's proposed theory of two-phased flow of gas, the highest Cₚ value attainable by a wind generator with a horizontal axis is 0.598, and the highest power coefficient attainable by a Darrieus type vertical axis wind generator is 0.35. However, these coefficients are theoretical, and coefficients achieved in practice fall short of these theoretical maximums. When a Savonius generator (which is the representative type of vortex wind generator), having two impeller wings as in a Blackwell, was tested, when the tip speed ratio λ was 0.8, the maximum value derived was 0.2. In WO 2005/108783, which is hereby incorporated by reference, a three-winged variation of the Savonius generator is set forth. Also, in WO 2005/010355, which is hereby incorporated by reference, a Darrieus vortex-type turbine is proposed, with wings in a spiraled, helical shape and tips thereof acting as vanes. Furthermore, Okamoto has proposed a Darrieus turbine coupled with a Savonius turbine to form a hybrid.

Although the performance of a vertical axis turbine that spins at high speeds can be estimated using lift theory with regards to lift around the wings, it is not easy to estimate the performance of a Savonius type turbine that rotates at a lower speed, due to its operating according to drag so that it operates in a non-stationary state. This Savonius drag-type vertical axis turbine is easy to manufacture, and is advantageous in that it can generate torque by rotating at low speeds. Moreover, while horizontal axis turbines must be stopped when they exceed their generator capacities, because vertical axis turbines generate torque and not lift, they can control their rotating speed in high winds. Also, servicing of components in a vertical axis generator is easy.

On the other hand, because vertical axis turbines generally rotate slowly, they require speed conversion. Vertical axis turbines are also half as efficient as horizontal axis turbines.

As shown in FIG. 1, in a Savonius drag-type vertical axis turbine, the positions at which wind hits the wings changes to 1, 2, and 3, to create torque that varies according to the size of the relative speed (W) and direction of the oncoming wind. While horizontal axis turbines generate positive torque regardless of their rotated position, vertical axis turbines have the problem in that they generate negative torque so that the overall power coefficient value decreases. Furthermore, in the case of impellers that have closed passages, because the incoming wind energy toward the wings is converted to pressure, the amount of torque generated is proportional to the root of the speed. Accordingly, Savonius drag-type vertical axis turbines have the problem of not being able to control the speed of the wind blowing against the wings.

To solve the above problems, WO 2004/018872 and Korean Patent Application No. 2005-0034732, which are hereby incorporated by reference, propose vertical turbines with fixed guiding vanes disposed circumferentially around the impellers and extending radially. There are also many other proposals in which guiding vanes of various shapes are installed at the receiving portion of the impeller and vertical turbine, in order to accelerate the wind speed against the impellers.

### DISCLOSURE

### Technical Problem

However, in this type of conventional drag-type turbine, the efficiency of the vane rotating speed ratio fluctuates widely, so that not only is there a need to create a guiding vane at the entrance to increase the speed of incoming wind, but there is also the need to control the rpm of the impeller according to the measured speed of wind blowing against the impeller.

Also, in the case of a conventional drag-type turbine, when a straight impeller of an inlet guiding airfoil is installed at the upstream portion, the main streamlines formed converge to the right by means of the impeller rotation, as shown in FIG. 2. A detailed numerical analysis of FIG. 3 shows an oncoming wind speed of 5 m/s, where the exiting wind of an inlet guide vane 20, despite it being at the mouth of a large inlet guide vane having an exit surface ratio of approximately 3.83, is unable to flow entirely into the entrance and flows to regions of low resistance, so that increase of streamlines corresponding to the surface area does not occur.

### Technical Solution

Accordingly, the present invention is directed to a jet wheel type vertical axis turbine that substantially obviates one or more problems due to limitations and disadvantages of the related art.

An object of the present invention is to provide a jet wheel type vertical axis turbine that blocks flow of air inside the impeller, so that a high speed jet pressure on the inlet guide vane is converted to a constant pressure between the blades disposed downstream of the flow which has passed through the inlet guide vane, thus generating a large amount of torque. Also, a large vortex is created around the region of the blades disposed downstream of the inlet guide vane that generate negative torque, so that negative torque is minimized.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, there is provided a wind power generating system having a plurality of turbines installed coaxially on a vertical axis on a support, and a generator driven by the plurality of turbines, the wind power generating system including: an impeller including an upper plate, a lower plate, and a plurality of arc-shaped blades sealed to prevent airflow therethrough; an arc-shaped inlet guide vane fixed to a frame connected through a separate bearing to an axis of the impeller, the inlet guide vane for accelerating a speed of wind blowing against the plurality of blades and converting the wind to a constant pressure between the blades and generating torque; a tail wing portion fixed to the frame, for controlling a position with respect to a direction of the wind; a gear assembly disposed between the axis of the impeller and the generator, for driving the impeller to uniformly maintain a vane rotating speed ratio to yield a high energy conversion efficiency, regardless of constantly varying wind speeds, with respect to a fixed frequency of a power supply system; and a controller for performing feedback controlling of a jet speed signal when a pressure difference is inputted from a Pitot tube or a speed sensor installed within the inlet guide vane and the wind speed increases and a speed of the jet is controlled, and controlling a rotating axis of the inlet guide vane through a step motor, for an inlet angle to exist between the wind direction and an entrance of the inlet guide vane, for uniformly maintaining the vane rotating speed ratio.

The wind power generating system may further include a side rear surface guide vane installed at a side of the frame, for using a collecting of main lines of flow in a rotating direction through rotation of the impeller, to increase efficiency of the wind power generating system.

The inlet guide vane may have a distribution between a maximum value of a chord that is not covered by more than half of a radius of the impeller when the inlet guide vane is projected in a reverse flow direction, and a minimum value of the chord for minimizing loss through shortening an inlet passage, such that an accelerating result is generated in a chord of the inlet guide vane that is minimally long when a pitch of the blade is equal to an entire span of the inlet guide vane.

The inlet guide vane may have an outlet angle distribution formed by a relative speed vector of the blade inlet and the blade, of between at least −10° to +10°.

A pitch (p) between two of the inlet guide vane may be derived through designating an entire span pitch of the inlet guide vane as a multiple integer of a blade pitch, for generating torque of a cycle parallel to an inlet jet of the blade.

The wind power generating system may be modularized for utilizing minimal surface area of land and simultaneously having a highly efficient vertical axis turbine, through forming diameters of impellers at different levels in consideration of a generating power requirement of each module, after estimating wind speeds at a central point of each module within boundary layers thereof.

The controller may perform feedback control of the rotating axis of the inlet guide vane through the step motor to adjust an inlet angle between the wind direction and the entrance of the inlet guide vane, for preventing an overload of the generator through ensuring an outlet jet of the inlet guide vane does not exceed rated values according to a pre-inputted maximum speed (V_{c}) therefor and a pre-inputted operating vane speed ratio (λₘᵢₙ, λₘₐₓ), and the controller secures a degree of efficiency of the wind generator system, regardless of wind speed, through adjusting the connected gear ratio of the generator differently according to a calculated value of the vane speed ratio from an rpm sensor of the impeller, and operates within an allowable operating vane speed ratio.

The impeller, the inlet guide vane, and the frame may be supported by a horizontal axis, and a surface of the tail wing portion controlling the position according to the wind direction is installed vertically on a side opposite to the horizontal axis.

### ADVANTAGEOUS EFFECTS

An advantage of the present invention is that by reducing the resistance within the inlet guide vane, feeding a flow of high speed wind toward the impeller blades at a suitable angle, optimizing the chord length of the inlet guide vane, the curvature of the inlet guide vane, and the exit angle of the inlet guide vane at an operating vane speed ratio for the pitch of one or many impeller blades, and by giving impellers at different levels diameters that are calculated based on a requirement to satisfy a generating power of each turbine module and wind speeds at a central point of each turbine module within boundary layers thereof, the land area used is minimized and a vertical axis turbine of high efficiency can be obtained.

Also, not only is the oncoming wind speed increased by installing the inlet guide vane, but the drawbacks of a drag type turbine with a large variation in efficiency can be overcome by using the controller to control a connected gear ratio of the generator, a number of generator poles, and generator torque differently according to wind speed ranges for each level (0<Ucut-in<Urated<Ucut-out), control an impeller rpm at a suitable level according to a wind speed (Vⱼₑₜ) measured against the impeller at each level, through performing a feedback control of a step motor or a hydraulic motor of a rotating shaft of the inlet guide vane, such that an outlet jet speed of the inlet guide vane operates in a range under a pre-inputted maximum operating value (V_{c}), and adjust a blown direction between the wind direction and an entrance of the inlet guide vane, for operating the wind power generating system within a vane speed ratio range (λₘᵢₙ<λ<λₘₐₓ), such that an increase in efficiency is attained regardless of wind speed.

It is to be understood that both the foregoing general description and the following detailed description of the present invention are exemplary and explanatory and are intended to provide further explanation of the invention as claimed.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view showing torque output of a Savonius drag-type vertical shaft turbine, according to the position of the impeller;

FIG. 2 is a view showing flow line distribution around a jet wheel type turbine impeller having a straight inlet guide vane;

FIG. 3 is a diagram showing an example of speed distribution (C=5 m/s) of wind flow passing a straight inlet guide vane;

FIG. 4 is a schematic perspective view of a jet wheel type vertical axis wind turbine according to an embodiment of the present invention;

FIG. 5 is a schematic perspective showing the gear assembly in FIG. 4;

FIG. 6 is a two-dimensional diagram showing geometric variables of an inlet guide vane and rotor blade shown in FIG. 4;

FIG. 7 is a diagram showing a triangle formed by a speed vector at the outlet of the inlet guide vane in FIG. 4, the rotating speed vector at the tip of the rotor blade, and a relative speed vector of the rotor blade inlet;

FIGS. 8 through 13 are diagrams showing various embodiments of a rotor according to changes in the inlet angles of rotor blades, of which the upper and lower surfaces are sealed;

FIGS. 14 through 19 are diagrams showing various embodiments of rotors according to changes in the inlet angles of the rotor blades, of which the upper and lower surfaces are sealed;

FIG. 20 is a diagram of a design embodiment of an impeller with an open upper and lower surface at a diameter Do of the opening of the rotor;

FIG. 21 is a graph comparing the respective performance characteristics of when both the upper plate and lower plate of a turbine to which an inlet guide vane of the present invention is installed are closed, when only one of the upper and lower plates are open, and when both the upper and lower plates are open;

FIG. 22 is a diagram showing design variables of a side rear guide vane of a jet wheel type vertical axis turbine according to the present invention;

FIG. 23 is a graph comparing performance characteristics when an inlet guide vane (I.G.V.) and a side rear guide vane (S.G.V.) are installed and when they are not installed;

FIG. 24 is diagram showing design variables of rotor size in stages for a wind generating system employing a jet wheel type vertical axis wind turbine according to the present invention;

FIG. 25 is a perspective view of an example of a module-type structure of a jet wheel type vertical axis wind turbine according to the present invention that is supported by a truss structure;

FIG. 26 is a perspective view of an example of a module-type structure of a jet wheel type vertical axis wind turbine according to the present invention that is supported by a rail structure;

FIGS. 27 and 28 are diagrams showing formative sections of impeller wings and upper and lower plates by module of a jet wheel type vertical axis wind turbine according to the present invention; and

FIGS. 29 and 30 are flowcharts showing control algorithms employed by a jet wheel type vertical axis wind turbine according to the present invention.

### BEST MODE

Reference will now be made in detail to the preferred embodiments of a jet wheel type vertical axis turbine and a wind generator system employing the same, according to the present invention, examples of which are illustrated in the accompanying drawings. Wherever possible, the same reference numbers will be used throughout the drawings to refer to the same or like parts.

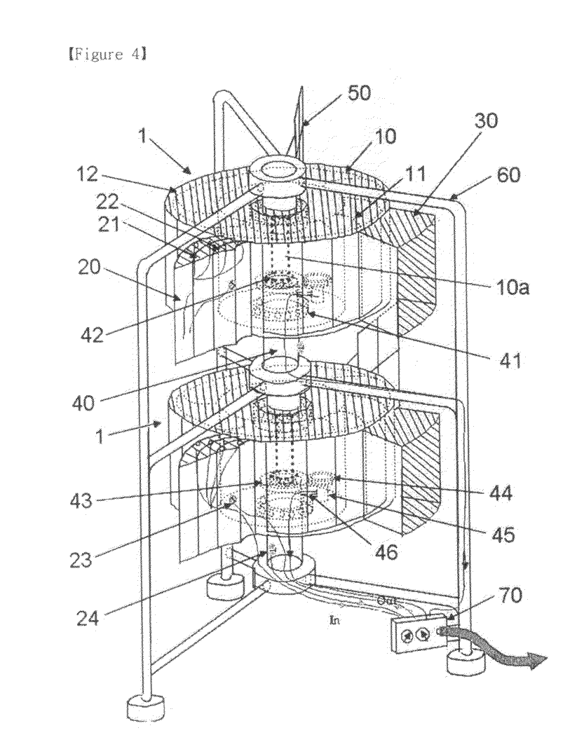

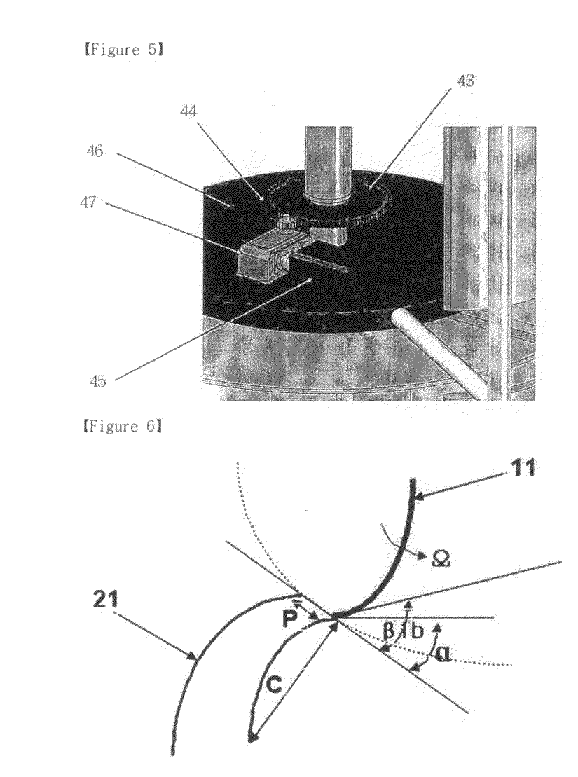

FIG. 4 is a schematic perspective view of a jet wheel type vertical axis wind turbine according to an embodiment of the present invention, and FIG. 5 is a schematic perspective showing the gear assembly in FIG. 4.

First, a jet wheel type vertical axis turbine and a wind generator system employing the same according to the present invention includes a pair of turbines 1 co-axially disposed one above the other, a speed sensor 23, a gear assembly 44, a generator 45, a plurality of turbine supports 60, and a controller 70.

The pair of turbines 1 (having the same configuration) are disposed one above the other with a predetermined space therebetween on a common fixed shaft 40 that is fixed by the plurality of turbine supports 60. Below, a description will be given of only one of the two in the pair of turbines. A turbine 1 includes an impeller 10, inlet guide vanes 20 and 21, an inlet guide vane rotating shaft 22, a side rear surface guide vane 30, and a tail wing portion 50.

Being different from an impeller in a conventional Savonius turbine, the impeller 10 blocks wind flow with a circular arc shaped blade 11 and top and bottom plates.

The inlet guide vanes 20 and 21 are fixed to a frame 12 connected to a bearing 41 that is separate from that of an impeller shaft 10a, so that wind blowing toward the wings is accelerated and a constant pressure can be maintained between the blades 11 to generate torque.

The side rear surface guide vane 30 and the tail wing portion 50 are respectively fixed at sides of the frame 12, and the tail wing portion 50 especially adjusts the incoming direction of wind.

The gear assembly 44 is disposed between the impeller shaft 10a and the generator 45, and uses a generator torque controlling method that maintains a high level of energy efficiency, regardless of constantly fluctuating wind speeds with respect to a fixed frequency of the electrical power system, and a constant rotating speed of the vanes. Here, in the case of a high-output 1 MW generator, the gear assembly 44 may be a multi-speed assembly with two or more helical or bevel gears, in order to attain a gear ratio of 1:100 or higher.

When a pressure discrepancy is measured by a Pitot tube or the speed sensor 23 installed between the inlet guide vanes 20 and 21 and the wind speed increases so that the speed of the jet must be controlled, the controller 70 feeds back the speed signal of the jet to control the received direction of the wind and the angle of the inlet between the inlet guide vanes 20 and 21 through controlling the rotation of the inlet guide vane rotating shaft 22 of the inlet guide vane 20 through a step motor, in order to maintain a uniform rotating speed of the turbine.

Elements not described in FIGS. 4 and 5 include an inlet guide vane case shaft thrust bearing 41, an impeller shaft thrust bearing 42, a drive shaft gear 43, and a generator support 46.

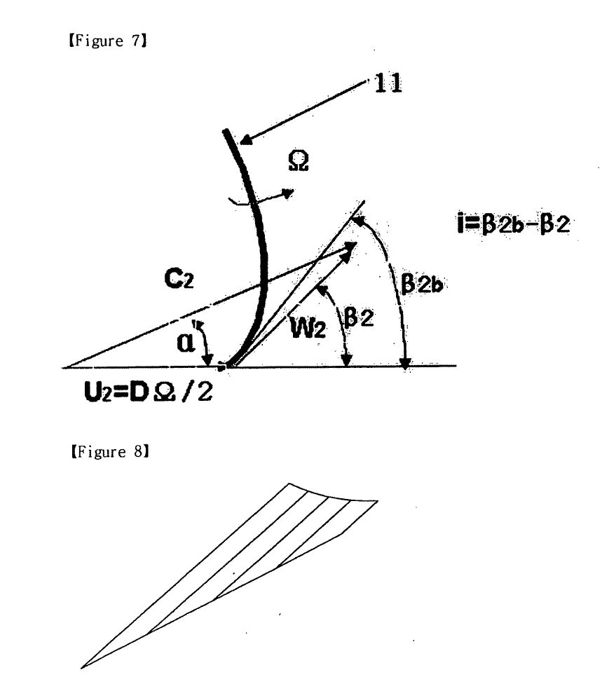

FIG. 6 is a two-dimensional diagram showing geometric variables of an inlet guide vane and rotor blade shown in FIG. 4, and FIG. 7 is a diagram showing a triangle formed by a speed vector at the outlet of the inlet guide vane in FIG. 4, the rotating speed vector at the tip of the rotor blade, and a speed vector of a relative speed vector of the rotor blade inlet.

As shown in FIG. 7, the forming factors of the inlet guide vanes 20 and 21 that affect the increase in performance of the above-described turbine 1 may be defined as the cord length (C) of the inlet guide vanes, a ratio (pitch-chord ratio) of the pitch (p) of the inlet guide vanes to the chord length (C) thereof, a curvature of the inlet guide vanes, and an outlet angle (α) of the inlet guide vanes.

In the present invention, in order to minimize loss of energy within the inlet passage formed by the inlet guide vane 20 by minimizing its length and forming a curvature thereof, an optimum outlet angle of the inlet guide vane 20 is given by altering the pitch of one or many impeller blade(s) to correspond to the given rotating speed ratio.

FIG. 6 is a two-dimensional plan view showing geometrical variables of the inlet guide vane 21 and the impeller blade 11. Here, the outlet angle (α) of the inlet guide vane 21 and the inlet angle (β_{1b}) of the impeller blade 11 are respectively the angles formed between the outlet tangent of the inlet guide vane 21 and the inlet tangent of the blade 11 with the rotating direction at the end of the blade 11.

FIG. 7 shows a triangular speed vector shape of the speed vector C₁ of the inlet guide vane 20, the rotating speed vector U₁ of the end of the blade 11, and the relative speed vector W₂ of the blade 11 inlet. Here, the inlet angle of attack (i) is defined as β_{1b}-β₁. Also, Zₛ and Zᵣ are the number of inlet guide vanes 20 and 21 and blades 11, and when θ₀ is defined as the angle between the blades 11, the minimum and maximum values for the distribution of chord lengths (C) of the inlet guide vane 20 can be derived using Equation 3 below.

$$\frac{\frac{D}{2} sin ( \frac{{θ}_{o}}{{Z}_{s} - 1} )}{sin ( 50 ) \leq {C}_{1} , {C}_{2} , … , {C}_{n} \leq \frac{1 - sin ( m {θ}_{o} )}{2 sin ( 40 )}} \qquad [ Equation 3 ]$$

Here, D is the diameter of the impeller 10, n number of chord lengths of the inlet guide vane have values from C₁-Cₙ, m is an overall pitch of the inlet guide vane 20 that is, a whole number value of (Zₛ−1)p divided by the blade pitch. Also, the angle of attack (β_{1b}-β₁) formed by the blade inlet relative speed vector (W₁) and the blade is between −10° and +10°. Here, Equation 4 below can be used to obtain the outlet angle (α) of the inlet guide vane from the given B_{2b} and the range of the angle of attack function.

tan β₁(C₁ cos α−U₁)−C₁ sin α=0 [Equation 4]

Also, the distance between the rows of the inlet guide vane 20 that is also the pitch (p) is made to be the entire pitch of the inlet guide vane—that is, so that (Zₛ—1)p becomes a multiple integer of the blade pitch (m) and allow the blade intake jets to have parallel torque pulses. Moreover, it is also possible to reduce the amount of interactive noise by making the number (Zₛ) of inlet guide vanes 20 and 21 and the number (Zᵣ) of rotor blades 11 different from mutual integer multiples.

$$m \frac{π ( D + 2 ɛ )}{{Z}_{r} - 1} = ( {Z}_{s} - 1 ) p \qquad [ Equation 5 ]$$

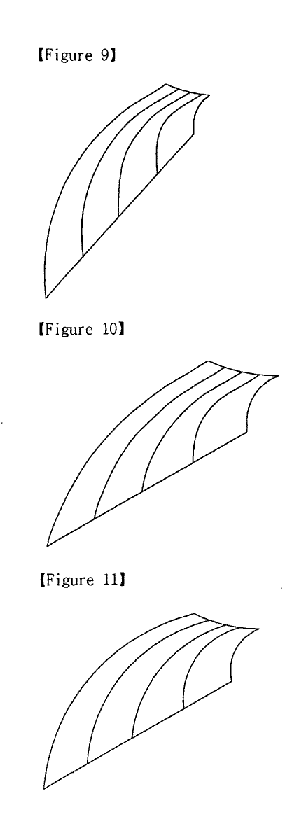

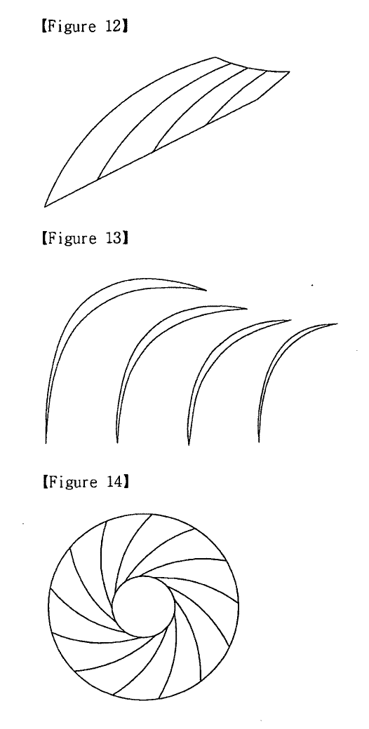

Here, ε is the design tolerance between the blade 11 and the inlet guide vane 20. Referring to FIGS. 8 through 12, various embodiments of the inlet guide vane 20 according to the present invention will be described using Equations 3 through 5. Of the embodiments, those in which the length of the inlet passage is minimized is preferable, in order to reduce loss in the passage and attain turbine efficiency. In FIG. 13, when the shape of each wing of the inlet guide vane is formed as an airfoil, the outlet angle (α) of the incoming air in each of the channels against the rotors may be made the same.

In the present invention, the high speed dynamic pressure from the inlet guide vanes 20 and 21 between the plurality of blades 11 juxtaposed to the inlet guide vanes 20 and 21 is maintained at a constant pressure or maintains consistency of positive pressure and negative pressure against either side of the blades in order to generate torque. Therefore, the impeller's performance varies according to the number of rotations of the impeller (S2), the diameter of the impeller (D), the diameter of the impeller hub (Ω), the diameter of the opening of the upper and lower plates (Dₒ), the number of blades (Zᵣ), and the inlet angles (β_{1b}) of the blades. As described above, the torque output of a Savonius vertical axis type turbine fluctuates widely according to its rotation, so that it is preferable to determine the number of wings (Zᵣ) based on the above Equation 5. The wing inlet angles (β_{1b}) are determined according to the rated vane speed ratio (λᵣ), and is generally a value between 10° and 70°.

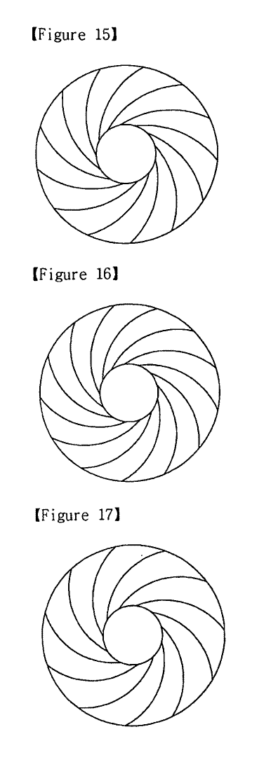

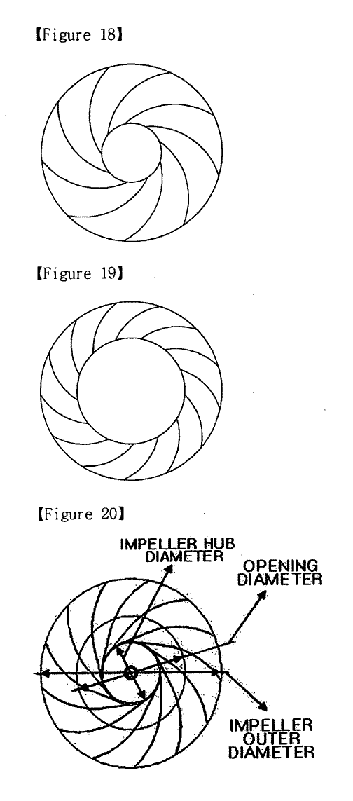

FIGS. 14 through 19 are diagrams showing various embodiments of rotors according to changes in the inlet angles of the rotor blades 11, of which the upper and lower surfaces are sealed, and FIG. 20 is a diagram of a design embodiment of an impeller with an open upper and lower surface at a diameter Do of the opening of the rotor.

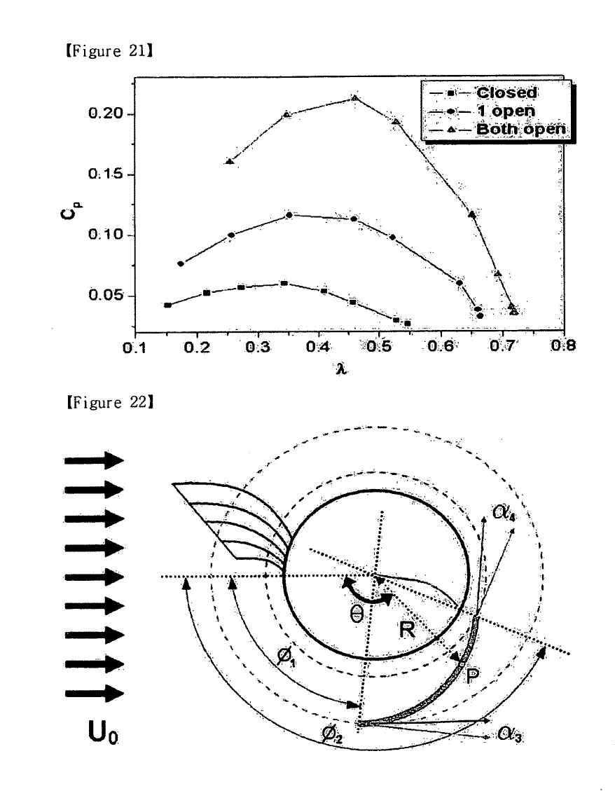

FIG. 21 shows the measured performance characteristics of the turbine when both the upper and lower plates, between which the inlet guide vanes are installed, are sealed, when one of the plates is opened, and when both the upper and lower plates are opened. The results show that in a large-sized turbine, the highest level of efficiency is derived when both the upper and lower plates are open.

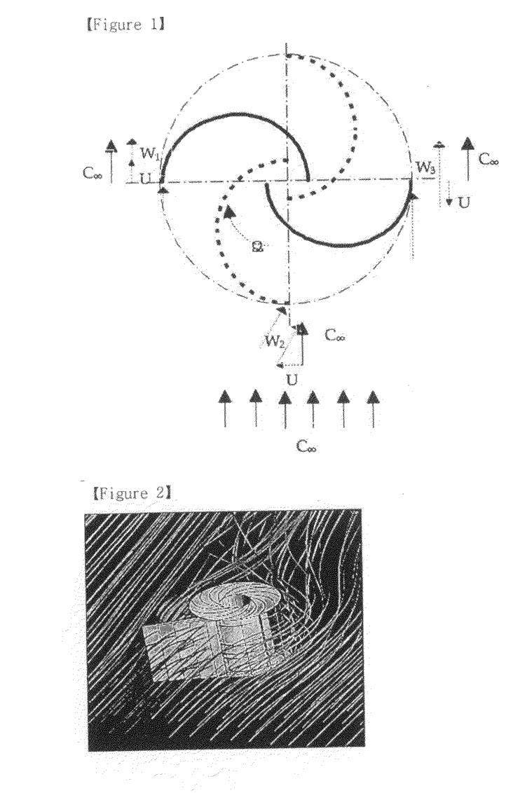

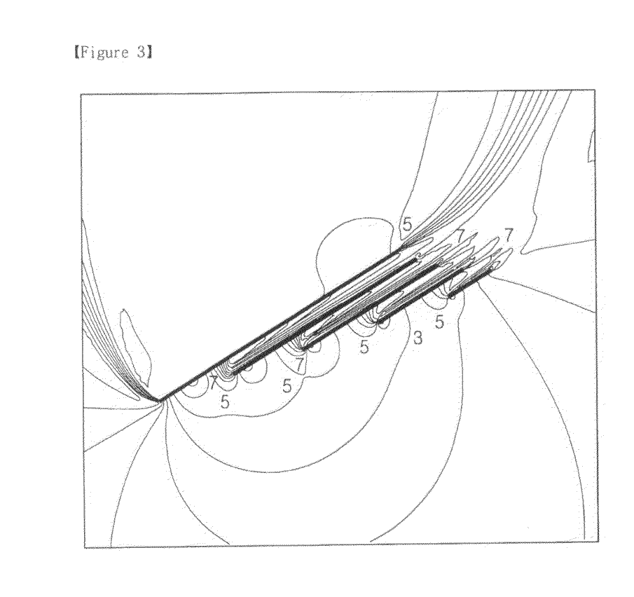

FIG. 22 is a diagram showing design variables of side rear guide vane of a jet wheel type vertical axis turbine according to the present invention. Φ₁ and Φ₂ are the respective inlet and outlet installed angles of the side rear surface guide vanes, and α₃ and α₄ are respective angles formed by the rotating direction of the rotor blades and an inlet tangent of a side rear surface guide vane, and the rotating direction of the rotor blades and an outlet tangent of a side rear surface guide vane, and P is shows the position of a central pivot axis of the side rear surface guide vane. The side rear surface guide vane allows the finely spaced lines to the right of the rotating rotor in FIG. 2 to collect again at the side rear surface and allow energy transfer to occur at the side rear surface, so that an operating vane rotating speed ratio in a wide range can be realized.

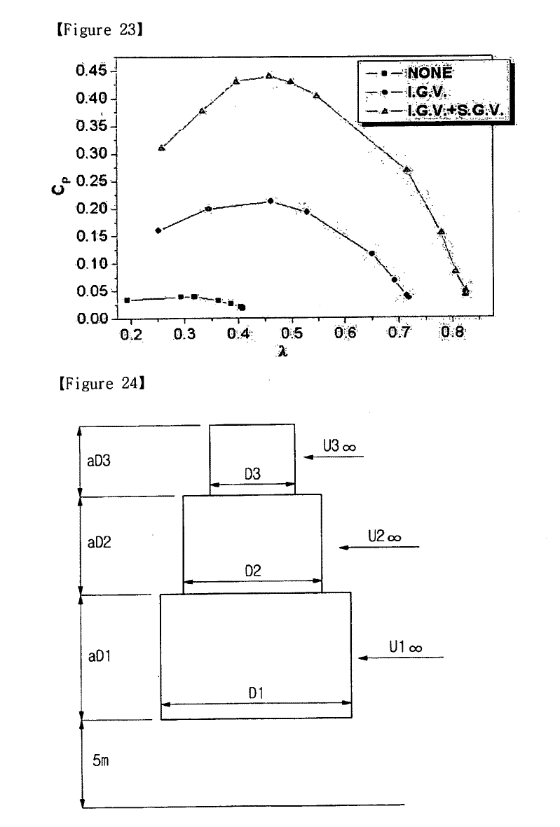

FIG. 23 is a graph comparing performance characteristics when an inlet guide vane (I.G.V.) and a side rear guide vane (S.G.V.) are installed and when they are not installed. When both the inlet guide vanes and the side rear surface guide vanes are installed, it can be seen that the maximum operating coefficient (Cₚ) can be as high as 0.44. Accordingly, installing both inlet guide vanes and side surface guide vanes provides a large sized turbine with the highest level of efficiency.

In order to minimize the surface area of land required by a large-sized wind turbine, a turbine module with two or more vertical axis jet wheel turbines may be used, as shown in FIG. 4. Here, the impeller diameter from end to end is designed keeping in mind changes in wind speed according to altitude (atmospheric boundary layers). That is, using Equation 6 below, after the wind speeds in the atmospheric boundary layers at the center of the turbine module are estimated, the impeller diameters at each level are calculated to satisfy the generating requirements for each module.

$${C}_{∞} = {{C}_{g} ( \frac{Z}{{Z}_{g}} )}^{\frac{1}{α}} \qquad [ Equation 6 ]$$

Here, in the case of a large plot of land, the coefficient showing the speed distribution has a value of approximately 1/0.16, and Z_{g} shows the thickness of a boundary layer.

FIG. 24 is diagram showing design variables of rotor size in stages for a wind generating system employing a jet wheel type vertical axis wind turbine according to the present invention. Here, the power for each module is

$$P = {C}_{p} \times {C}_{m} \times \frac{1}{2} ρ {aD}^{2} {C}_{∞}^{3}$$

Thus, the estimated wind speed (C_{∞}) at the center of the module using Equation 6 and an efficiency value Cₚ estimated using the vane speed ratio derived through Equation 2 are used to repeat the calculations of the diameters D for the turbines of the module. Here, a is the ratio of the height to the diameter of the impeller 10, Cₘ is the efficiency of the generator motor. Also the ratio of the impeller height to its diameter may be different for each turbine module.

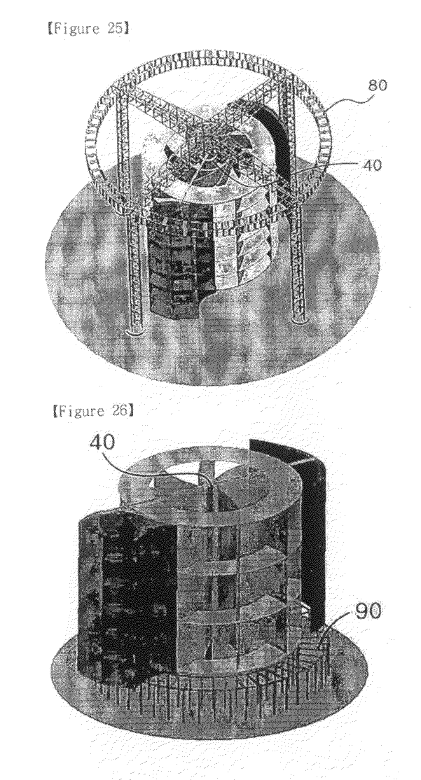

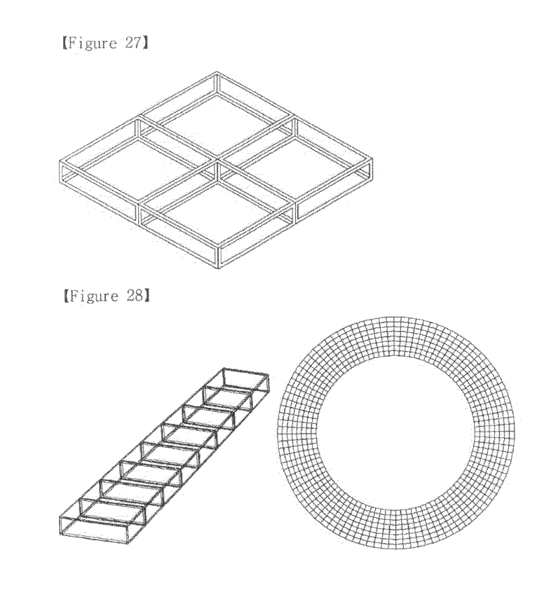

FIG. 25 is a perspective view of an example of a large-scale module-type structure of a jet wheel type vertical axis wind turbine according to the present invention with a fixing axis 40 is supported by a truss structure 80.

Also, FIG. 26 shows a large-scale module type jet wheel vertical axis wind turbine with a fixing axis 40 installed on a bed on a ground surface, and a rail structure 90 supporting a roller bearing, installed below the rotor blades and guide vanes to distribute the weight of the axis, to move over a rail above the bed on the ground.

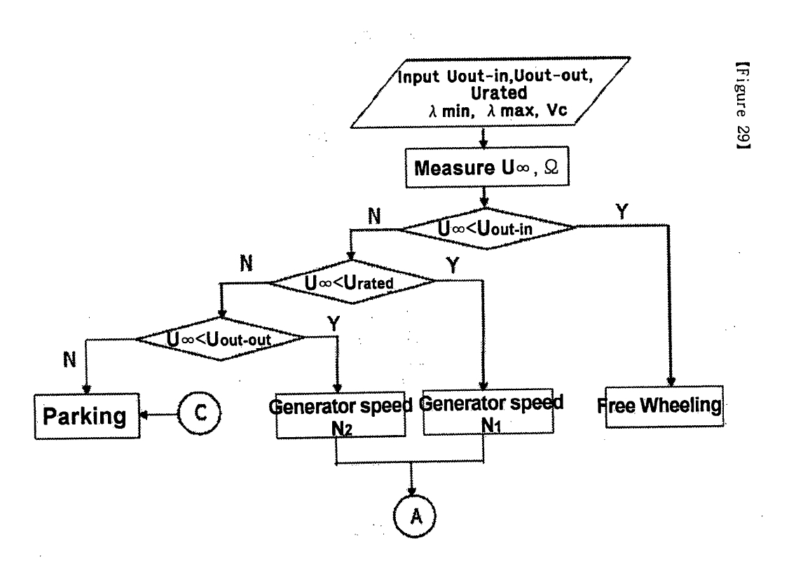

In order to reduce the weight of the fixing axis 40 of the large-scale module-type jet wheel vertical axis wind turbine, the impeller 10 blades and the upper and lower plates for each module are configured in a frame structure (as shown in FIG. 27), a truss structure (as shown in FIG. 28), or a membrane structure (not shown) formed over a truss.

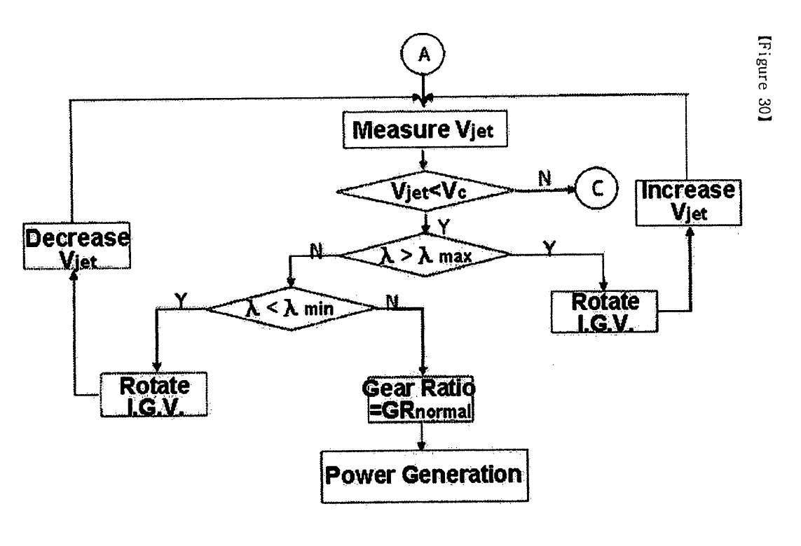

FIGS. 29 and 30 are flowcharts showing control algorithms employed by a jet wheel type vertical axis wind turbine according to the present invention.

In the present invention, the inlet guide vane 20 is installed to not only increase the speed of oncoming wind, but also control the rotation of the impellers according to a measured wind speed against the impellers using controlling algorithms as shown in FIGS. 29 and 30, in order to overcome the drawback of conventional large-scale drag-type turbines in their high degree of efficiency fluctuation. That is, in order to prevent the discharge jet speed at the inlet guide vanes from exceeding a maximum operating value, according to a preset maximum speed (V_{c}) of a discharge jet at the inlet guide vanes and an operating vane speed ratio value (λₘᵢₙ, λₘₐₓ), a step motor or a hydraulic motor is used to control (through feedback) the rotating shaft 22 of the inlet guide vanes 20 and 21, so that wind direction and the blown angle between the entrances of the inlet guide vanes can be controlled. Thus, overload of the generator through an excessive impeller rotating speed can be prevented, and the generator's connected gear ratio or the generator's torque can be controlled differently in accordance with a vane speed ratio value calculated by an rpm sensor such as a Hall sensor, so that the generator operates within an acceptable operating speed of the vanes.

It will be apparent to those skilled in the art that various modifications and variations can be made in the present invention. Thus, it is intended that the present invention covers the modifications and variations of this invention provided they come within the scope of the appended claims and their equivalents.

1. A wind power generating system having a plurality of turbines installed coaxially on a vertical axis on a support, and a generator driven by the plurality of turbines, the wind power generating system comprising:
an impeller including an upper plate, a lower plate, and a plurality of arc-shaped blades sealed to prevent airflow therethrough;
an arc-shaped inlet guide vane fixed to a frame connected through a separate bearing to an axis of the impeller, the inlet guide vane for accelerating a speed of wind blowing against the plurality of blades and converting the wind to a constant pressure between the blades and generating torque;
a tail wing portion fixed to the frame, for controlling a position with respect to a direction of the wind;
a gear assembly disposed between the axis of the impeller and the generator, for driving the impeller to uniformly maintain a vane rotating speed ratio to yield a high energy conversion efficiency, regardless of constantly varying wind speeds, with respect to a fixed frequency of a power supply system; and
a controller for performing feedback controlling of a jet speed signal when a pressure difference is inputted from a Pitot tube or a speed sensor installed within the inlet guide vane and the wind speed increases and a speed of the jet is controlled, and controlling a rotating axis of the inlet guide vane through a step motor, for an inlet angle to exist between the wind direction and an entrance of the inlet guide vane, for uniformly maintaining the vane rotating speed ratio.

2. The wind power generating system of claim 1, further comprising a side rear surface guide vane installed at a side of the frame, for using a collecting of main lines of flow in a rotating direction through rotation of the impeller, to increase efficiency of the wind power generating system.

3. The wind power generating system of claim 1, wherein the inlet guide vane has a distribution between a maximum value of a chord that is not covered by more than half of a radius of the impeller when the inlet guide vane is projected in a reverse flow direction, and a minimum value of the chord for minimizing loss through shortening an inlet passage, such that an accelerating result is generated in a chord of the inlet guide vane that is minimally long when a pitch of the blade is equal to an entire span of the inlet guide vane.

4. The wind power generating system of claim 1, wherein the inlet guide vane has an outlet angle distribution formed by a relative speed vector of the blade inlet and the blade, of between at least −10° to +10°.

5. The wind power generating system of claim 1, wherein a pitch (p) between two of the inlet guide vane is derived through designating an entire span pitch of the inlet guide vane as a multiple integer of a blade pitch, for generating torque of a cycle parallel to an inlet jet of the blade.

6. The wind power generating system of claim 1, wherein a number (Zₛ) of inlet guide vanes and a number (Zᵣ) of rotor blades are multiples of one another except for integer multiples, for reducing repeating interactive noise.

7. The wind power generating system of claim 1, wherein the blades of the impeller are installed in plurality in an arc-shape on only an end portion of a radius of the impeller, to secure 30% to 90% of an interior space for facilitating manufacturing and maintenance of the generator and gear assembly.

8. The wind power generating system of claim 1, wherein impellers at different levels have diameters that are calculated based on a requirement to satisfy a generating power of each turbine module and wind speeds at a central point of each turbine module within boundary layers thereof.

9. The wind power generating system of claim 1, wherein the controller performs feedback control of the rotating axis of the inlet guide vane through the step motor to adjust an inlet angle between the wind direction and the entrance of the inlet guide vane, for preventing an overload of the generator through ensuring an outlet jet of the inlet guide vane does not exceed rated values according to a pre-inputted maximum speed (V_{c}) therefor and a pre-inputted operating vane speed ratio (λ , , , ; , , , λₘₐₓ), and the controller secures a degree of efficiency of the wind generator system, regardless of wind speed, through adjusting the connected gear ratio of the generator differently according to a calculated value of the vane speed ratio from an rpm sensor of the impeller, and operates within an allowable operating vane speed ratio.

10. The wind power generating system of claim 1, wherein the impeller, the inlet guide vane, and the frame are supported by a horizontal axis, and a surface of the tail wing portion controlling the position according to the wind direction is installed vertically on a side opposite to the horizontal axis.

11. A wind power generating system having a plurality of turbines installed coaxially on a vertical axis on a support, and a generator driven by the plurality of turbines, the wind power generating system comprising:
an impeller including an upper plate, a lower plate, and a plurality of arc-shaped blades having an airflow therethrough;
an arc-shaped inlet guide vane fixed to a frame connected through a separate bearing to an axis of the impeller, the inlet guide vane for accelerating a speed of wind and converting the wind to a positively pressurized surface and a negatively pressurized surface to generate torque;
a tail wing portion and a rotation controller fixed to the frame, for controlling a position of the inlet guide vane according to a direction of the wind;
a gear assembly disposed between the axis of the impeller and the generator and connected to the impeller, for implementing a generator torque controlling method to drive the impeller to uniformly maintain a vane rotating speed ratio to yield a high energy conversion efficiency, regardless of constantly varying wind speeds, with respect to a fixed frequency of a power supply system; and
a controller for performing feedback controlling of a jet speed signal when a pressure difference is inputted from a Pitot tube or a speed sensor installed within the inlet guide vane and the wind speed increases and a speed of the jet is controlled, and controlling a rotating axis of the inlet guide vane through a step motor or a hydraulic motor, for an inlet angle to exist between the wind direction and an entrance of the inlet guide vane, for uniformly maintaining the vane rotating speed ratio.

12. The wind power generating system of claim 11, further comprising a side rear surface guide vane installed at a side of the frame, for using a collecting of main lines of flow in a rotating direction through rotation of the impeller, to increase efficiency of the wind power generating system.

13. The wind power generating system of claim 11, wherein one or both of the upper and lower panels of the impeller is opened at 20% or more of an entire surface of the panels, and torque efficiency is increased through converting wind against the blade to the positively and negatively pressurized surfaces of the blade to generate a constant pressure difference.

14. The wind power generating system of claim 11, wherein each wing of the inlet guide vane has an airfoil shape, and the inlet guide vane has an outlet angle that forms the same rotor blower angle for each channel of the inlet guide vane.

15. The wind power generating system of claim 11, wherein when the wind power generating system is a large-capacity system of IMW or higher, the gear assembly is a multi-gear helical or bevel gear assembly with two or more gears and a 1:100 or higher gear ratio.

16. The wind power generating system of claim 11, wherein the inlet guide vane has a distribution between a maximum value of a chord that is not covered by more than half of a radius of the impeller when the inlet guide vane is projected in a reverse flow direction, and a minimum value of the chord for minimizing loss through shortening an inlet passage, such that an accelerating result is generated in a chord of the inlet guide vane that is minimally long when a pitch of the blade is equal to an entire span of the inlet guide vane.

17. The wind power generating system of claim 11, wherein the inlet guide vane has an outlet angle distribution formed by a relative speed vector of the blade inlet and the blade, of between at least −10° to +10°.

18. The wind power generating system of claim 11, wherein a pitch (p) between two of the inlet guide vane is derived through designating an entire span pitch of the inlet guide vane as a multiple integer of a blade pitch, for generating torque of a cycle parallel to an inlet jet of the blade.

19. The wind power generating system of claim 11, wherein a number (Zₛ) of inlet guide vanes and a number (Zᵣ) of rotor blades are made to not be integer multiples of one another, for reducing repeating interactive noise.

20. The wind power generating system of claim 11, wherein the blades of the impeller are installed in plurality in an arc-shape on only an end portion of a radius of the impeller, to secure an interior space sufficient for facilitating manufacturing and maintenance of the generator and gear assembly.

21. The wind power generating system of claim 11, wherein the wind power generating system is modularized for utilizing minimal surface area of land and simultaneously having a highly efficient vertical axis turbine, through forming diameters of impellers at different levels in consideration of a generating power requirement of each module, after estimating wind speeds at a central point of each module within boundary layers thereof.

22. The wind power generating system of claim 11, wherein the vertical axis is supported at a top portion by a truss structure installed on a ground surface.

23. The wind power generating system of claim 11, wherein the vertical axis is supported by a rail structure installed on a bed on a ground surface, the rail structure including a rail over which a roller moves, the roller having lower ends of the impeller blades and the guide vane installed thereon, for distributing a load on the vertical shaft.

24. The wind power generating system of claim 11, wherein the impeller blades and the upper and lower plates for each module are configured in a frame or a truss structure, whereby a surface of the frame or truss structure is covered with a membrane, for reducing load on the vertical axis.

25. The wind power generating system of claim 11, wherein the controller controls a connected gear ratio of the generator, a number of generator poles, and generator torque differently according to wind speed ranges for each level (0<Ucut-in<Urated<Ucut-out), controls an impeller rpm at a suitable level according to a wind speed (Vjₑt) measured against the impeller at each level, through performing a feedback control of a step motor or a hydraulic motor of a rotating shaft of the inlet guide vane, such that an outlet jet speed of the inlet guide vane operates in a range under a pre-inputted maximum operating value (V_{c}), adjusts a blown direction between the wind direction and an entrance of the inlet guide vane, for operating the wind power generating system within a vane speed ratio range (λₘᵢₙ<λ<λₘₐₓ), such that an increase in efficiency is attained regardless of wind speed.

26. The wind power generating system of claim 11, wherein the impeller, the inlet guide vane, and the frame are supported by a horizontal axis, and a surface of the tail wing portion controlling the position according to the wind direction is installed vertically on a side opposite to the horizontal axis.

27. The wind power generating system of claim 22, wherein the impeller blades and the upper and lower plates for each module are configured in a frame or a truss structure, whereby a surface of the frame or truss structure is covered with a membrane, for reducing load on the vertical axis.

28. The wind power generating system of claim 23, wherein the impeller blades and the upper and lower plates for each module are configured in a frame or a truss structure, whereby a surface of the frame or truss structure is covered with a membrane, for reducing load on the vertical axis.
